(19) United States
(12) Patent Application Publication
(10) Pub. No.: US 2010/0290207 A1
(43) Pub. Date: Nov. 18, 2010

(54) Emergency LED light device

(75) Inventors: Mao Hua Chan, Taipei (TW); Li-Hsing Kuan, Taipei (TW); Wen Hao Guo, Taipei (TW)

Correspondence Address: CHARLES E. BAXLEY, ESQUIRE, 90 JOHN STREET, SUITE 309, NEW YORK, NY, 10038, US

(73) Assignee: Jing Yuan Technology Co., Ltd.

(21) Appl. No.: 12/454,211

(22) Filed: May 14, 2009

(51) Int. Cl. F21V 19/04

(52) U.S. Cl. 362/20; 362/183

(57) ABSTRACT

An emergency light device includes a housing having an upper flange, a barrel having a peripheral rib engaged with the flange for latching the barrel to the housing and having a partition for forming two compartments, a plate disposed in the upper compartment and secured to the barrel and having a number of light members, a circuit board disposed in the lower compartment of the barrel and secured to the barrel and having a control circuit for controlling the light members, and a battery for energizing the light members, the circuit board and the plate may be solidly secured to the partition of the barrel, and the barrel may be quickly attached to the housing and to a hood, and the light device may be used as a flashlight or a hand-held light, and a night light.

### BACKGROUND OF THE INVENTION

1. Field of the Invention

The present invention relates to an emergency light emitting diode (LED) light device, and more particularly to an emergency LED light device including a structure for allowing the light device to be easily and quickly assembled.

2. Description of the Prior Art

Typical emergency light devices comprise a battery disposed in a receptacle and coupled to a light bulb for energizing the light bulb, and for generating the indicating light or the flash light or the emergency light.

For example, U.S. Pat. No. 4,368,507 to Reynolds, U.S. Pat. No. 5,154,600 to Sylvestre, and U.S. Pat. No. 5,483,956 to Shapiro disclose three of the typical flashlights, illumination kits, or night lights, and each comprising a light bulb coupled to a battery for generating various lights.

However, the lights generated by the light bulbs are not good for lighting the road in the night, and the typical flashlights, illumination kits, or night lights may not be easily used or operated by the users, and may not be used or operated selectively for the night lights and the hand-held flashlights and the emergency lights respectively, particularly when the electric power source is cut off or has become failure.

The present invention has arisen to mitigate and/or obviate the afore-described disadvantages of the conventional emergency light devices.

### SUMMARY OF THE INVENTION

The primary objective of the present invention is to provide an emergency light device including a structure for allowing the light device to be easily and quickly assembled.

In accordance with one aspect of the invention, there is provided an emergency light device comprising a housing including a chamber formed therein, and including a peripheral flange extended upwardly from an upper portion thereof, a barrel disposed on top of the housing and including a first peripheral rib extended downwardly therefrom for engaging with the peripheral flange of the housing and for latching the barrel to the housing, the barrel including a second peripheral rib extended upwardly therefrom, and including a partition disposed in the barrel for forming a lower compartment and an upper compartment in the barrel, a plate disposed in the upper compartment of the barrel and secured to the barrel and including a plurality of light members attached onto the plate, a hood disposed on top of the barrel and including a peripheral fence extended downwardly therefrom for engaging with the second peripheral rib of the barrel and for securing the hood to the barrel, and for closing the upper compartment of the barrel and for shielding and protecting the plate and the light members, a circuit board disposed in the lower compartment of the barrel and secured to the barrel and including a control circuit attached to the circuit board for controlling the light members, and a battery received in the lower compartment of the barrel for supplying an electric energy to energize the light members, in which the circuit board and the plate may be solidly secured to the partition of the barrel and may be spaced from each other, and the barrel may be easily and quickly attached or secured onto the housing, and the hood may be easily and quickly attached or secured onto the barrel such that the light device may be easily and quickly assembled, and may be used as a flashlight or a night light.

The barrel includes at least one cavity formed therein, and the housing includes at least one catch extended therefrom for engaging with the cavity of the barrel and for latching the barrel to the housing and for preventing the barrel from rotating relative to the housing.

The cavity of the barrel is formed in the first peripheral rib to the housing, and the catch is extended from the peripheral flange and extended into the chamber of the housing for engaging with the cavity of the barrel.

The circuit board includes a first coupler, and the plate includes a second coupler electrically coupled to the light members and electrically coupled to the first coupler for electrically coupling the light members to the circuit board.

The circuit board is secured to the partition of the barrel with at least one spacer for spacing the circuit board from the partition of the barrel and also for suitably spacing the circuit board from the plate.

The barrel includes an aperture formed in the partition, and the plate includes an opening formed therein and aligned with the aperture of the partition of the barrel, and the circuit board includes a light element engaged through the aperture of the partition of the barrel and engaged through the opening of the plate for allowing the lights generated by the light element to be transmitted out through the hood.

The circuit board includes a first coupler, and the battery includes a second coupler electrically coupled to the first coupler of the circuit board.

The control circuit of the circuit board includes a processor device coupled to the light members and the battery for operating the light members.

The control circuit includes a driving circuit coupled to the processor device and coupled to the light members for allowing the processor device to operate the light members.

The control circuit includes a sensing circuit coupled to the processor device and coupled to the battery for detecting a power level of the battery.

The control circuit includes a charging circuit coupled to the battery for charging the battery. The control circuit includes a stabilizing circuit coupled to the charging circuit and coupled to the processor device.

The control circuit includes a contact detecting circuit coupled to the processor device and coupled to the stabilizing circuit, and a switch coupled to the contact detecting circuit for detecting whether the switch has been depressed or not.

The control circuit includes a converter, a starting circuit coupled to the stabilizing circuit, and a detecting circuit coupled to the processor device and coupled to the starting circuit.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of an emergency light device in accordance with the present invention;

FIG. 2 is a bottom perspective view of the emergency light device;

FIG. 3 is an upper perspective view of the emergency light device in which a hood has been removed for showing the inner structure of the emergency light device;

FIG. 4 is a cross sectional view of the emergency light device taken along lines 4-4 of FIG. 2;

FIG. 5 is an enlarged partial cross sectional view of the emergency light device;

FIGS. 6, 7 are enlarged partial upper perspective views illustrating the portions of the emergency light device;

FIG. 8 is an enlarged partial bottom perspective view illustrating the barrel of the emergency light device;

FIG. 9 is a block diagram illustrating the electric circuit of the emergency light device; and

FIG. 10 is an upper perspective view illustrating the operation of the emergency light device.

### DETAILED DESCRIPTION OF THE PREFERRED EMBODIMENT

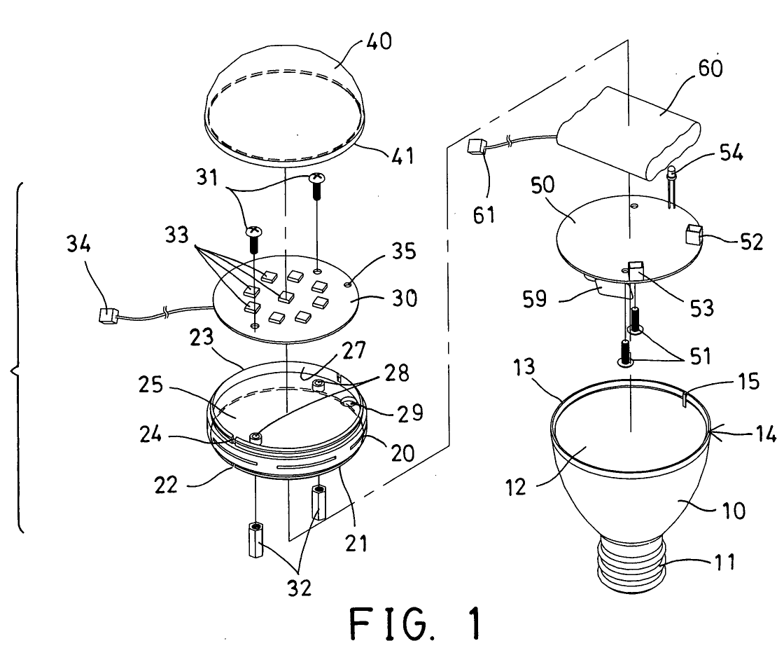

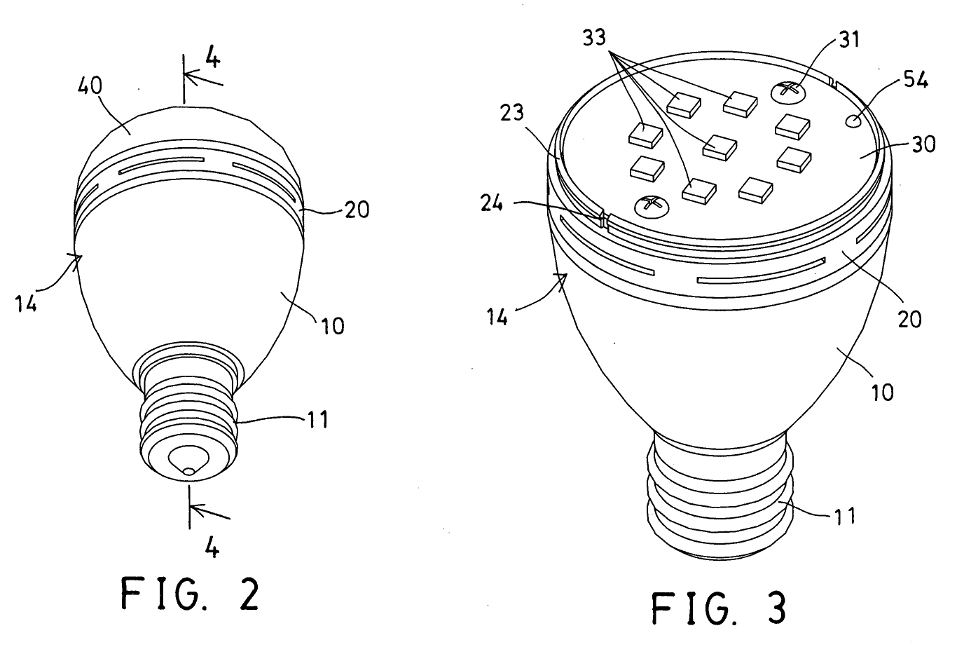

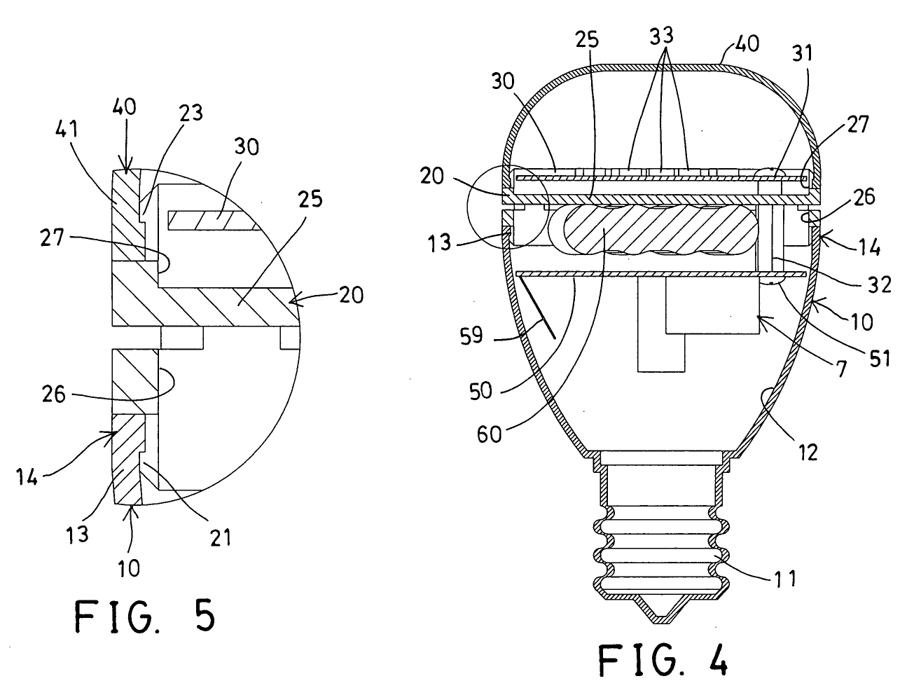

Referring to the drawings, and initially to FIGS. 1-4, an emergency light device in accordance with the present invention comprises a receptacle or housing 10 including one end or lower portion or plug or head 11 for coupling to a typical electrical sockets (not shown) and for receiving the electric power or energy from the electrical sockets (not shown), and including a chamber 12 formed therein, and including a peripheral flange 13 extended upwardly from the upper portion 14 thereof, and including one or more (such as two) catches 15 extended from the peripheral flange 13 and extended into the chamber 12 of the housing 10.

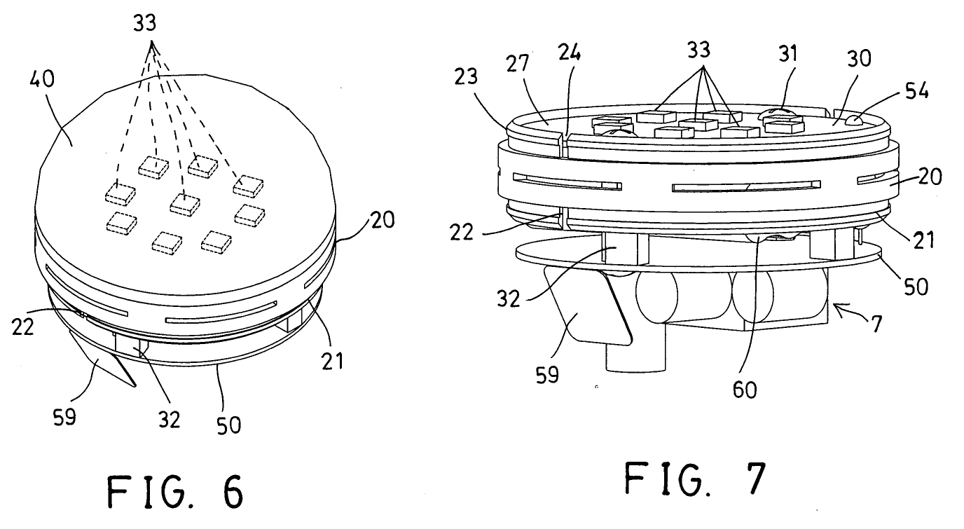

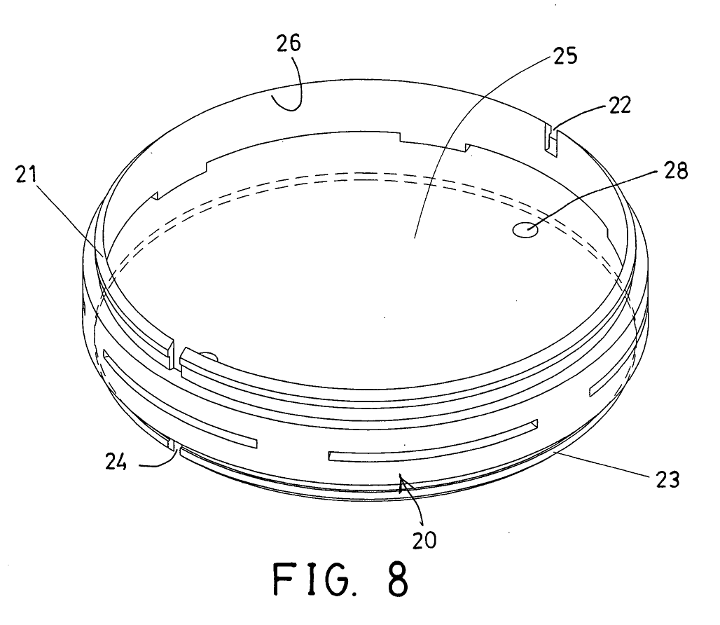

As shown in FIGS. 1-8, a coupler or sleeve or barrel 20 is disposed on top of the housing 10, and includes a peripheral rib 21 extended downwardly therefrom for engaging with the peripheral flange 13 of the housing 10 and for latching or anchoring or securing the barrel 20 to the housing 10, and includes one or more (such as two) cavities 22 formed therein, such as formed in the peripheral rib 21 (FIGS. 1 and 6-8) for engaging with the catches 15 and for further latching or anchoring or securing the barrel 20 to the housing 10 and for preventing the barrel 20 from rotating relative to the housing 10.

The barrel 20 may further include another peripheral rib 23 extended upwardly therefrom, and one or more (such as two) cavities 24 formed therein, such as formed in the peripheral rib 23, and includes a partition 25 formed or provided in the middle portion thereof or disposed in the barrel 20 for separating the inner portion the barrel 20 into a lower compartment 26 and an upper compartment 27 or for forming a lower compartment 26 and an upper compartment 27 in the barrel 20, and includes one or more (such as two) orifices 28 and an aperture 29 formed therein, such as formed in the partition 25 (FIG. 1). The barrel 20 may thus be easily and quickly attached or assembled or secured onto the housing 10 by the engagement of the peripheral flange 13 of the housing 10 with the peripheral rib 21 of the barrel 20 and by the engagement of the catches 15 of the housing 10 with the cavities 22 of the barrel 20.

A plate 30 is disposed or engaged into the upper compartment 27 of the barrel 20 and secured to the barrel 20 with one or more (such as two) fasteners 31 which are engaged through the plate 30 and also engaged through the orifices 28 of the partition 25 of the barrel 20 and which may be directly threaded and secured to the barrel 20, or the fasteners 31 may be engaged through the orifices 28 of the partition 25 of the barrel 20 and threaded and secured to the spacers 32. A number of light bulbs or light members 33, such as the light emitting diode (LED) light members 33 are attached or secured onto the plate 30, and electrically coupled to a plug or socket or coupler 34. The plate 30 includes an opening 35 formed therein (FIG. 1) and aligned with the aperture 29 of the partition 25 of the barrel 20.

A transparent or semi-transparent hood 40 is disposed on top of the barrel 20, and includes a peripheral fence 41 extended downwardly therefrom for engaging with the peripheral rib 23 of the barrel 20, and for latching or anchoring or securing the hood 40 to the barrel 20, and for suitably covering or closing the upper compartment 27 of the barrel 20 and for suitably shielding or protecting the plate 30 and the light members 33, and for preventing the dirt or dust or contaminant from entering into the upper compartment 27 of the barrel 20, and also for allowing the lights generated by the light bulbs or the light members 33 to be suitably transmitted out through the hood 40.

A circuit board 50 is disposed or engaged into the lower compartment 26 of the barrel 20 and secured to the barrel 20 with one or more (such as two) fasteners 51 which are engaged through the circuit board 50 and threaded and secured to the spacers 32 for securing the circuit board 50 to the barrel 20 and for suitably spacing the circuit board 50 from the plate 30 and the partition 25 of the barrel 20, the circuit board 50 includes a socket or plug or coupler 52 for electrically coupling to the coupler 34 of the plate 30 and the light members 33, and includes another socket or plug or coupler 52 for electrically coupling to a plug or socket or coupler 61 of an electric power source or battery 60 which is received or engaged in the lower compartment 26 of the barrel 20 and which may supply the electric power source or energy to energize the light bulbs or the light members 33.

The circuit board 50 further includes an indicating light element 54 attached thereto or extended upwardly therefrom and engaged through the aperture 29 of the partition 25 of the barrel 20 and also engaged through the opening 35 of the plate 30 for allowing the light element 54 to be extended or engaged into the hood 40 and thus for allowing the lights generated by the light element 54 to be transmitted out through the hood 40 and to indicate whether the emergency light device is working or not, and the circuit board 50 further includes an electric control circuit 7 attached to the circuit board 50 for controlling the light members 33 and/or the light element 54.

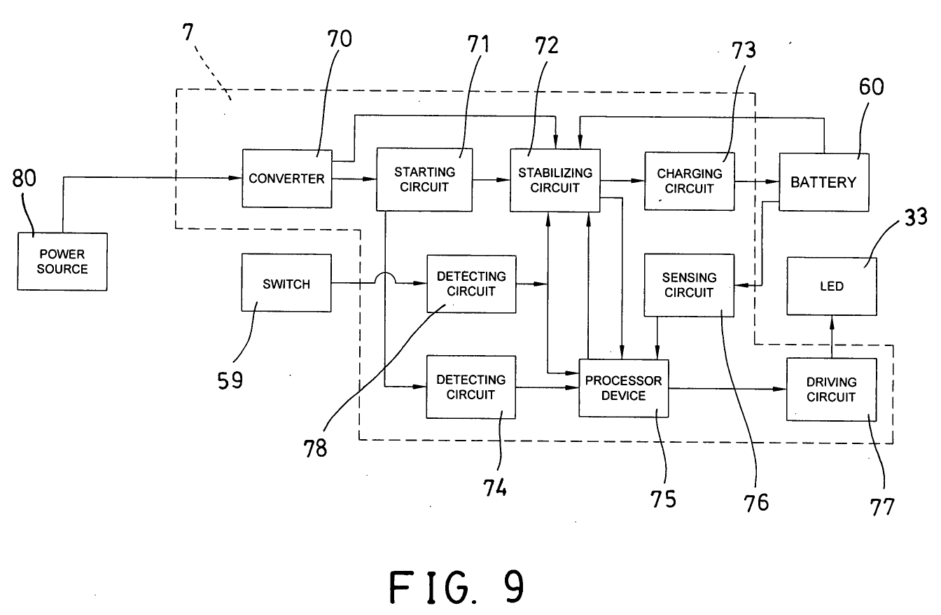

As shown in FIG. 9, the electric control circuit 7 includes a converting circuit or converter 70 coupled to a building electric power source 80 or the like, and coupled to a resetting or starting circuit 71 which is coupled to a stabilizing circuit 72, the stabilizing circuit 72 may be directly coupled to the power source or battery 60 and/or coupled to the power source or battery 60 indirectly with a charging circuit 73 for suitably charging the power source or battery 60 to the required voltage or level, a detecting circuit 74 is coupled to the starting circuit 71 and coupled to a central processing unit or processor device 75 for detecting whether the electric power source 80 has suitably supply the electric power or energy to the starting circuit 71 or not.

The processor device 75 is coupled to the detecting circuit 74 and the stabilizing circuit 72 for receiving the signals or information from the detecting circuit 74 and the stabilizing circuit 72, and is coupled to the power source or battery 60 with a detecting or sensing circuit 76 for detecting or sensing whether the electric power or voltage of the power source or battery 60 is reached the predetermined power level or not or for detecting the power level of the power source or battery 60. If not, the processor device 75 may actuate the charging circuit 73 to suitably charge the power source or battery 60 to the required voltage or level. On the contrary, when the power source or battery 60 has reached the predetermined power level, the processor device 75 will not actuate the charging circuit 73 to charge the power source or battery 60.

The electric control circuit 7 further includes a driving circuit 77 coupled to the processor device 75 and is coupled to the LED light members 33 for allowing the processor device 75 to suitably drive or operate or actuate the light members 33 to generate the lights with the driving circuit 77 when required. When the electric power source 80 has not suitably supplied the electric power or energy to the starting circuit 71, or when the head 11 of the housing 10 is disengaged from the electrical sockets, and when the housing 10 is used as a flashlight or a hand-held light, the processor device 75 may actuate the power source or battery 60 to supply the electric power source or energy to energize the light bulbs or the light members 33.

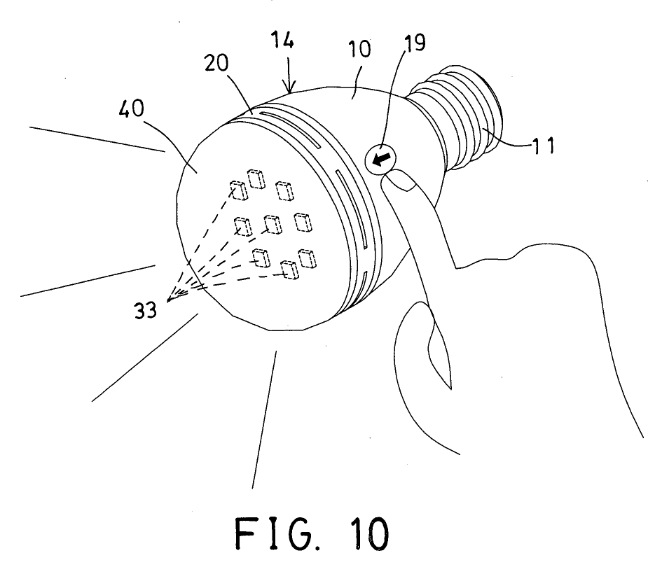

The circuit board 50 further includes a switch 59, such as a contact or depress switch 59 coupled to the processor device 75 and the stabilizing circuit 72 with a contact or depression sensing or detecting circuit 78 which may sense or detect whether the switch 59 has been contacted or depressed by a user or not, in order to operate or to actuate the processor device 75 to charge the power source or battery 60 and/or to actuate the driving circuit 77 to operate the light members 33, or to actuate the power source or battery 60 to supply the electric power source or energy to energize the light bulbs or the light members 33. As shown in FIG. 10, the housing 10 may include a flexible or soft or resilient button or knob 19 aligned with the switch 59 for allowing the switch 59 to be depressed or actuated by the user.

In operation, as shown in FIG. 10, the user may depress or actuate the button or knob 19 and the switch 59 to operate the processor device 75 to actuate the driving circuit 77 to operate the light members 33, or to actuate the power source or battery 60 to supply the electric power source or energy to energize the light bulbs or the light members 33 and to generate the lights. When the electric power source 80 has not or may not suitably supply the electric power or energy to the starting circuit 71, or when the head 11 of the housing 10 is disengaged from the electrical sockets, and when the housing 10 is used as a flashlight or a hand-held light, the processor device 75 may actuate the power source or battery 60 to supply the electric power source or energy to energize the light bulbs or the light members 33.

It is to be noted that the circuit board 50 and the plate 30 may be solidly secured to the partition 25 of the barrel 20 with the fasteners 31, 51 and may be suitably spaced or separated from each other with the spacers 32, in addition, the barrel 20 may be easily and quickly attached or assembled or secured onto the housing 10, and the hood 40 may be easily and quickly attached or assembled or secured onto the barrel 20 such that the emergency light device in accordance with the present invention may be easily and quickly assembled, and may be used as a flashlight or a hand-held light, and a night light, or the like.

Accordingly, the emergency light device in accordance with the present invention includes a structure for allowing the light device to be easily and quickly assembled.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An emergency light device comprising:
a housing including a chamber formed therein, and including a peripheral flange extended upwardly from an upper portion thereof,
a barrel disposed on top of said housing and including a first peripheral rib extended downwardly therefrom for engaging with said peripheral flange of said housing and for latching said barrel to said housing, said barrel including a second peripheral rib extended upwardly therefrom, and including a partition disposed in said barrel for forming a lower compartment and an upper compartment in said barrel,
a plate disposed in said upper compartment of said barrel and secured to said barrel and including a plurality of light members attached onto said plate,
a hood disposed on top of said barrel and including a peripheral fence extended downwardly therefrom for engaging with said second peripheral rib of said barrel and for securing said hood to said barrel, and for closing said upper compartment of said barrel and for shielding and protecting said plate and said light members,
a circuit board disposed in said lower compartment of said barrel and secured to said barrel and including a control circuit attached to said circuit board for controlling said light members, and
a battery received in said lower compartment of said barrel for supplying an electric energy to energize said light members.

2. The emergency light device as claimed in claim 1, wherein said barrel includes at least one cavity formed therein, and said housing includes at least one catch extended therefrom for engaging with said at least one cavity of said barrel and for latching said barrel to said housing and for preventing said barrel from rotating relative to said housing.

3. The emergency light device as claimed in claim 2, wherein said at least one cavity of said barrel is formed in said first peripheral rib to said housing, and said at least one catch is extended from said peripheral flange and extended into said chamber of said housing.

4. The emergency light device as claimed in claim 1, wherein said circuit board includes a first coupler, and said plate includes a second coupler electrically coupled to said light members and electrically coupled to said first coupler.

5. The emergency light device as claimed in claim 1, wherein said circuit board is secured to said partition of said barrel with at least one spacer for spacing said circuit board from said partition of said barrel.

6. The emergency light device as claimed in claim 1, wherein said barrel includes an aperture formed in the partition, and said plate includes an opening formed therein and aligned with the aperture of the partition of the barrel, and said circuit board includes a light element engaged through said aperture of said partition of said barrel and engaged through said opening of said plate.

7. The emergency light device as claimed in claim 1, wherein said circuit board includes a first coupler, and said battery includes a second coupler electrically coupled to said first coupler of said circuit board.

8. The emergency light device as claimed in claim 1, wherein said control circuit of said circuit board includes a processor device coupled to said light members and said battery for operating said light members.

9. The emergency light device as claimed in claim 8, wherein said control circuit includes a driving circuit coupled to said processor device and coupled to said light members for allowing said processor device to operate said light members.

10. The emergency light device as claimed in claim 8, wherein said control circuit includes a sensing circuit coupled to said processor device and coupled to said battery for detecting a power level of said battery.

11. The emergency light device as claimed in claim 8, wherein said control circuit includes a charging circuit coupled to said battery for charging said battery.

12. The emergency light device as claimed in claim 11, wherein said control circuit includes a stabilizing circuit coupled to said charging circuit and coupled to said processor device.

13. The emergency light device as claimed in claim 12, wherein said control circuit includes a contact detecting circuit coupled to said processor device and coupled to said stabilizing circuit, and a switch coupled to said contact detecting circuit for detecting whether said switch has been depressed or not.

14. The emergency light device as claimed in claim 12, wherein said control circuit includes a converter, a starting circuit coupled to said stabilizing circuit, and a detecting circuit coupled to said processor device and coupled to said starting circuit.
